(19) United States
(12) Patent Application Publication
(10) Pub. No.: US 2011/0202215 A1
(43) Pub. Date: Aug. 18, 2011

(54) METHOD AND DEVICE FOR OPERATING A HYBRID DRIVE OF A VEHICLE

(76) Inventors: Jens-Werner Falkenstein, Aalen (DE); Manfred Hellmann, Hardthof (DE)

(21) Appl. No.: 12/737,457

(22) PCT Filed: Jul. 14, 2009
(86) PCT No.: PCT/EP2009/058997

§ 371 Date: Apr. 4, 2011

(30) Foreign Application Priority Data
Jul. 15, 2008 (DE) 10 2008 040 400.4

(51) Int. Cl. B60W 20/00; B60W 10/08; B60W 10/10; B60W 10/26; B60K 6/48

(52) U.S. Cl. 701/22; 180/65.275; 180/65.25; 903/930

(57) ABSTRACT

In a method for operating a hybrid drive of a vehicle, which is driven by a combustion engine and an electric motor, the electric motor is supplied with energy from an energy store having a power reserve and the power of the combustion engine is supplemented by the power of the electric motor during a hybrid drive operation. In a situation in which the vehicle is to be removed as quickly as possible from a dangerous situation, the energy supplied from the energy store to the electric motor is supplied from the power reserve of the energy store when a dangerous situation is detected.

### BACKGROUND OF THE INVENTION

1. Field of the Invention

The present invention relates to a method for operating a hybrid drive of a vehicle, which is driven by a combustion engine and an electric motor, the electric motor being supplied with energy from an energy store having a power reserve, and the power of the combustion engine being supplemented by the power of the electric motor in a hybrid drive operation, and to a device for implementing the method.

2. Description of the Related Art

Vehicles having a hybrid drive structure have a combustion engine and, as a second drive unit, an electric motor. Thus, when driving the hybrid vehicle, the drive torque may be applied by both drive units. If more propulsive torque is demanded than what the combustion engine is able to provide, then additional electrical energy for the electric motor is provided from an energy store for propulsion. (Boost operation).

Published international patent application document WO 2007/107463 A1 describes a method for operating a hybrid drive for a vehicle, in which power is increased by supplementing the power of the combustion engine by electromotive power. Since the energy quantity of the electrical energy store associated with the electric motor is limited, the power increase above the power of the combustion engine can only be temporary. The temporary power increase occurs only until a limit speed is reached, which makes it possible to maintain a longer boost operation using the available energy content of the energy store or to distribute the available energy content of the energy store over multiple boost processes.

In order to maintain the performance of the energy store, the power, which is taken from the energy store in a boost operation, is limited, even though the energy store still has a power reserve, from which the energy store could supply a higher power. However, withdrawing this power reserve puts great stress on the energy store and thus results in a reduction of the lifespan of the energy store.

### BRIEF SUMMARY OF THE INVENTION

The method according to the present invention for running up a hybrid vehicle has the advantage that in certain dangerous situations the power reserve of the energy store of the electric motor is used so as to be able to leave a danger zone quickly. This danger zone may be for example a passing maneuver, during which oncoming traffic suddenly appears, or an intersection, which must be left immediately because of intersecting traffic.

In order to release the power reserve of the energy store, a dangerous situation must first be identified. Advantageously, the dangerous situation is detected by evaluating the actuation of an accelerator pedal. In addition, the manner in which the driver actuates the accelerator pedal is analyzed. A dangerous situation may be detected in a particularly simple manner if the accelerator pedal is pressed down completely (kickdown of the accelerator pedal), which is what the driver normally does only in a critical situation.

The dangerous situation thus detected results in the release of the power reserve of the electrical energy store.

In another development, the gradient of the accelerator pedal angle is also evaluated in addition to the position of the accelerator pedal. A rapid change of the gradient permits one to assume that the driver quickly wants to evade a dangerous situation.

The release of the power reserve of the energy store for the so-called “danger boost” does not occur spontaneously, even if a dangerous situation was identified via the accelerator pedal. In another development of the present invention, the power reserve is released increasingly over a specified time period. The specified time period is a function of speed and/or gear step. This prevents the functionality from being misused by a so-called “racing start” since the power reserve is released quickly only from the second gear onward or above a minimum speed. At a low speed or in first gear, the release is delayed and/or released at a low gradient.

In one development, the power reserve of the energy store is released as long as the steering wheel angle falls below a specified angle. In cornering, this boost function is therefore disabled in order to prevent the vehicle from drifting in the curve and to avoid a possible risk of an accident.

In addition, the power reserve of the energy store is released if a vehicle dynamics system, particularly the electronic stability program (ESP) is active. In the event of a deactivation of the electronic stability program, the release of the power reserve is prohibited for safety reasons since in using the danger boost functionality according to the present invention, unstable driving situations e.g. on ice or snow may occur, which can only be compensated by the electronic stability program.

In one development, the power reserve of the energy store is released when a forward gear is engaged. When a reverse gear is engaged, the danger boost functionality is disabled.

After each completed release of the power reserve, the motor torque of the electric motor is reduced. This has the advantage that the energy store may be charged again. Furthermore, a misuse of the danger boost functionality without the necessary existence of a dangerous situation is prevented. Only with the beginning of a new driving cycle or following the expiry of a certain time period is it possible to request the power reserve again to the full extent. The reduction of the power reserve is indicated to the driver such that the driver is always informed as to when the danger boost functionality is available.

Since the method according to the present invention affects the service life of the energy store, the driver receives an indication following each release of the power reserve that the service life of the energy store is reduced.

If the vehicle has a driver assistance system, then in one development of the present invention the time delay of the release of the power reserve of the energy store may be cancelled if the driver assistance system detects the dangerous situation. Driver assistance systems such as ACC systems, for example, detect dangerous situations independently of the driver. Thus it is possible for the driver assistance system to detect an oncoming vehicle in the course of the host vehicle and react to it even before the driver is able to do so. In the future, such driver assistance systems will be able to detect dangers early and guard against them on the basis of a communication among the vehicles.

In another development of the present invention, a device for operating a hybrid drive of a vehicle has a combustion engine and an electric motor, the electric motor being supplied with energy from an energy store having a power reserve and the power of the combustion engine being supplemented by the power of the electric motor during a hybrid drive operation. In order to be able to remove the vehicle quickly from the critical area in dangerous situations, means are provided that enable the supply of energy from the energy store to the electric motor from the power reserve of the energy store when a dangerous situation is detected.

### BRIEF DESCRIPTION OF THE DRAWINGS

FIG. 1 shows a basic representation of a vehicle having a hybrid drive.

FIG. 2 shows a representation of the release of the power reserve as a function of the position of the accelerator pedal.

### DETAILED DESCRIPTION OF THE INVENTION

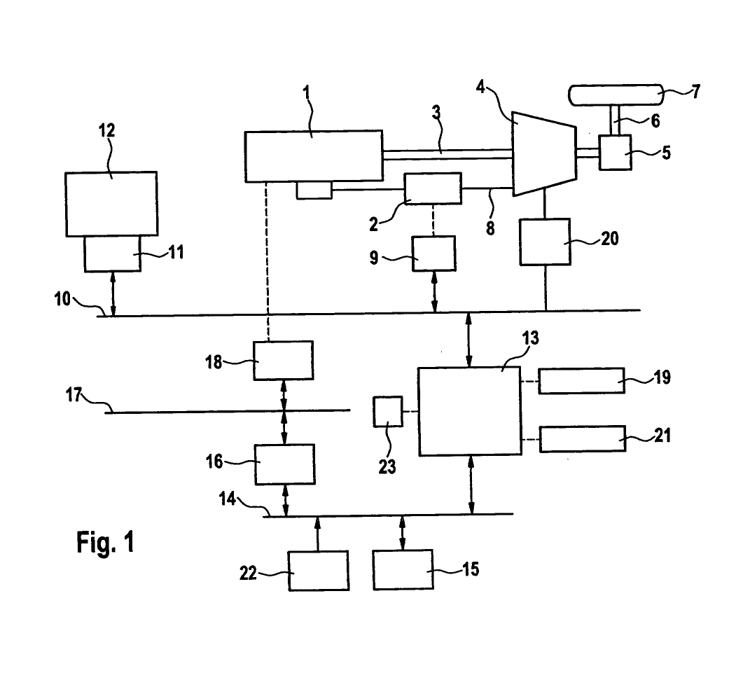

FIG. 1 shows a basic representation for a vehicle having a hybrid drive. The hybrid drive is formed by a combustion engine 1 as the first drive unit and an electric motor 2 as the second drive unit.

Combustion engine 1 is connected via drive train 3 to transmission 4, which in turn runs via differential 5 to wheel axle 6 for driving wheel 7.

Electric motor 2 is connected via a separate drive train 8 to transmission 4 and thus contributes to driving wheels 1 and to the total torque of the vehicle. In addition, electric motor 2 has a separate electric motor control unit 9, which is connected to a hybrid CAN bus 10, via which all of the control unites communicate with one another, which affect the hybrid-specific driving operation of the vehicle. This includes, among others, battery management system 11 of high-voltage battery 12 and a transmission control unit 20. High-voltage battery 12 is connected to electric motor 2 and supplies it with electrical energy.

A vehicle control unit 13 communications via hybrid CAN bus 10 with electric motor control unit 9 connected to it, with battery management system 11 and transmission control unit 20.

Furthermore, it is connected via CAN bus 14, among other things, to an ACC control unit 15, an ESP control unit 22 and other control units (not shown) of vehicle safety systems and driver assistance systems of the vehicle.

Via a gateway 16, CAN bus 14 is connected to a gateway CAN bus 17, via which the individual bus systems of the vehicle communicate with one another.

Engine control unit 18 of combustion engine 1 is connected via gateway CAN bus 17 and CAN bus 14 to vehicle control unit 13.

Vehicle control unit 13 is connected to an accelerator pedal sensor 19 and a vehicle speed sensor 21, from which vehicle control unit 13 receives information about the current operating parameters for the vehicle operation.

In the present system, the torque relevant for driving the vehicle is generated both by combustion engine 1 as well as by electric motor 2. If the vehicle is in a dangerous situation, this torque is insufficient such that it becomes necessary to release the power reserve of high-voltage battery 12 for electric motor 2, which is to be explained in more detail in the following.

Vehicle control unit 13 evaluates the data provided by accelerator pedal sensor 19, which the driver of the hybrid vehicle sets via the accelerator pedal.

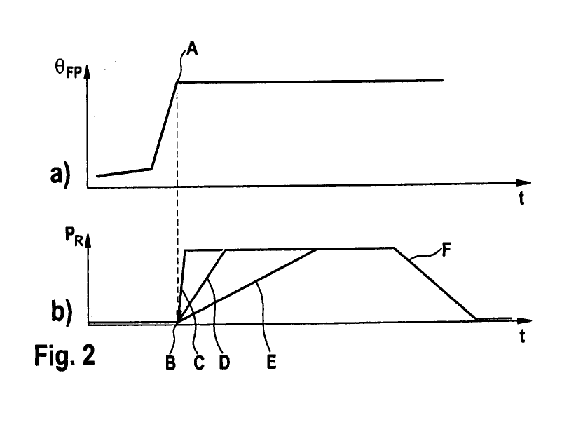

FIG. 2a shows accelerator pedal angle θ_{FP} over time, as it is detected by accelerator pedal sensor 19. If the accelerator pedal is pressed down completely, then the accelerator pedal has reached its maximum accelerator pedal position at point A. From this vehicle control unit 13 detects that the vehicle is in a special dangerous situation. To determine the dangerous situation, the gradient of the change of the angle over time dθ/dt may be evaluated as additional information. If this gradient is very great, then this is a further indication that the vehicle is in a critical situation.

Such critical situations may occur in passing maneuvers or on intersections.

If vehicle control unit 13 has detected such a dangerous situation, then the power reserve of high-voltage battery 12 of the hybrid vehicle is released in that vehicle control unit 13 outputs a signal to battery management system 11 via hybrid CAN bus 10.

FIG. 2b shows the released power reserve P_{R} for the danger boost over time. In the following, a danger boost is to be understood as the provision of electrical energy from the power reserve of high-voltage battery 12, which is utilized, however, only in dangerous situations.

At point B of FIG. 2b, which correlates with point A of FIG. 2a, battery management system 11 obtains the information that power reserve P_{R} is to be released. In this instance, power reserve P_{R} is not released completely, but gradually over time.

If the dangerous situation, which the driver has indicated by actuating the accelerator pedal, is confirmed by ACC control unit 15, which detects for example that an oncoming vehicle is in the lane of the hybrid vehicle, then the maximum power reserve P_{R} is released as quickly as possible (curve C). Here the information of ACC control unit 15 is transmitted to vehicle control unit 13, which outputs a signal containing this information to battery management system 11.

If vehicle control unit 13 receives the information from transmission control unit 20 that the vehicle is driven in a gear that is higher than the first gear, then, as shown in curve D, power reserve P_{R} is released more slowly than in the case of a confirmation of the dangerous situation on the part of ACC control unit 15. Power reserve P_{R} is released at the same rate if vehicle speed sensor 21 reports a driving speed higher than 30 km/h to vehicle control unit 13.

If the hybrid vehicle is driving in first gear and at a speed below 30 km/h, then power reserve P_{R} is released only gradually since here a misuse in a racing start would be possible, which is to be prevented. In this case, the release of power reserve P_{R} is delayed even more than when driving in second or a higher gear (curve E).

If vehicle control unit 13 detects via transmission control unit 20 that the reverse gear is engaged, then the release of power reserve P_{R} is prevented. The release of power reserve P_{R} is likewise prevented if the electronic stability program ESP is deactivated, which is indicated to vehicle control unit 13 by ESP control unit 22.

After each danger boost, power reserve P_{R} is deactivated, as shown in curve E. This is necessary in order to preserve high-voltage battery 12. This represents no additional disadvantage for the further driving operation, however, since the possibility of a vehicle entering into a dangerous situation multiple times in rapid succession is not frequently given. Hence the engine torque released for electric motor 2 is reduced after each danger boost. After a danger boost, vehicle control unit 13 controls a display 23 that signals to the driver that the danger boost resulted in a reduction of the service life of high-voltage battery 12

1-12. (canceled)

13. A method for operating a hybrid drive of a vehicle having a combustion engine and an electric motor, comprising:
supplying the electric motor with energy from an energy store having a power reserve; and
supplementing the power of the combustion engine by the power of the electric motor during a hybrid drive operation;
wherein, when a triggering situation is detected, the energy supplied from the energy store to the electric motor is supplied from the power reserve of the energy store.

14. The method as recited in claim 13, wherein the triggering situation is detected by an evaluation of an actuation of an accelerator pedal.

15. The method as recited in claim 14, wherein at least one of the position of the accelerator pedal and the gradient of the accelerator pedal angle is evaluated.

16. The method as recited in claim 13, wherein the power reserve of the energy store is released increasingly over a specified time period.

17. The method as recited in claim 16, wherein the specified time period is a function of at least one of speed and gear step.

18. The method as recited in claim 15, wherein the power reserve of the energy store is released as long as the steering wheel angle falls below a specified angle.

19. The method as recited in claim 15, wherein the power reserve of the energy store is released if an electronic stability program is active.

20. The method as recited in claim 15, wherein the power reserve of the energy store is released when a forward gear is engaged.

21. The method as recited in claim 15, wherein after each completed release of the power reserve, the motor torque of the electric motor is reduced.

22. The method as recited in claim 15, wherein after each completed release of the power reserve, an indication is provided to a driver of the vehicle indicating a reduction of the service life of the energy store has occurred.

23. The method as recited in claim 16, wherein time delay of the release of the power reserve of the energy store is cancelled if a driver assistance system detects the triggering situation.

24. A hybrid drive system of a vehicle, comprising:
a combustion engine;
an electric motor supplied with energy from an energy store having a power reserve, wherein the power of the combustion engine is supplemented by the power of the electric motor during a hybrid drive operation; and
a control system configured to supply energy from the power reserve of the energy store to the electric motor when a triggering situation is detected.
